(19) United States
(12) Patent Application Publication
(10) Pub. No.: US 2025/0251567 A1
(43) Pub. Date: Aug. 7, 2025

(54) IMAGE CAPTURING APPARATUS, CONTROL METHOD FOR THE SAME, AND STORAGE MEDIUM

(71) Applicant: CANON KABUSHIKI KAISHA, Tokyo (JP)

(72) Inventor: KOJI INOUE, Tokyo (JP)

(21) Appl. No.: 19/038,235

(22) Filed: Jan. 27, 2025

(30) Foreign Application Priority Data
Feb. 2, 2024 (JP) 2024-015049

(51) Int. Cl. G02B 7/28; G03B 13/32; G03B 35/10

(52) U.S. Cl. CPC G02B 7/28; G03B 13/32; G03B 35/10

(57) ABSTRACT

An image capturing apparatus on which a lens unit is mountable, acquires a characteristic of a mounted lens unit, receives a movement operation; and controls, in accordance with the movement operation, a position of an AF frame indicating a region in which a defocus amount is to be detected for an image capture signal. The apparatus performs control, based on the characteristic of the mounted lens unit, such that, with respect to the same movement amount of the movement operation, an amount of movement of the position of the AF frame is different depending on whether the mounted lens unit is a lens unit having a first characteristic of having an imaging optical system with one optical axis or a lens unit having a second characteristic of having a plurality of imaging optical systems with different optical axes.

### BACKGROUND OF THE INVENTION

### Field of the Invention

The present invention relates to an image capturing apparatus, a control method for the same, and a storage medium.

### Description of the Related Art

Conventionally, as an interchangeable lens (lens unit) that can be mounted on an interchangeable-lens camera, a lens unit having two optical systems facing in the same direction such that a Virtual Reality (VR) image can be acquired has been known (Japanese Patent Laid-Open No. 2022-189536). By using such a lens unit, it is possible to acquire two images with parallax that can be used to easily create a VR image with a single shot.

In addition, among lens units having one optical system or a plurality of optical systems, there are some that use central projection optical systems and can shoot a subject and an image similarly, and some that can shoot a wide range of 180 degrees or more in the up, down, left, and right directions (a hemisphere, 90 degrees in all directions from the center of the image). The latter are collectively known as fisheye lenses. In this way, various lens units can be used in an interchangeable-lens camera.

Incidentally, among cameras including an autofocus function, there are known to be cameras that have a function of moving an autofocus (AF) frame in accordance with a user operation in order to focus on a desired subject. The AF frame is a frame that indicates a region in which a defocus amount is to be detected for a displayed image capture signal. The displayed image capture signal changes depending on the mounted lens unit, which may affect the operational feel of the AF frame. In the conventional technology, no consideration was given to technology for appropriately controlling the AF frame in a case where lens units with different characteristics can be mounted.

### SUMMARY OF THE INVENTION

The present invention was made in view of the above-described problem and aims to realize a technology that makes it possible to move an AF frame to a desired position within a screen even in a case where lens units with different characteristics are used.

In order to solve the aforementioned issues, one aspect of the present disclosure provides an image capturing apparatus on which a lens unit is mountable, comprising: an acquisition unit configured to acquire a characteristic of a mounted lens unit; an operation unit configured to receive a movement operation; and a control unit configured to control, in accordance with the movement operation on the operation unit, a position of an AF frame indicating a region in which a defocus amount is to be detected for an image capture signal displayed on a display unit, wherein, based on the characteristic of the mounted lens unit, the control unit performs control such that, with respect to the same movement amount of the movement operation on the operation unit, an amount of movement of the position of the AF frame is different depending on whether the mounted lens unit is a lens unit having a first characteristic of having an imaging optical system with one optical axis or a lens unit having a second characteristic of having a plurality of imaging optical systems with different optical axes.

Another aspect of the present disclosure provides an image capturing apparatus on which a lens unit is mountable, comprising: an acquisition unit configured to acquire a characteristic of a mounted lens unit; an operation unit configured to receive a movement operation; and a control unit configured to control, in accordance with the movement operation on the operation unit, a position of an AF frame indicating a region in which a defocus amount is to be detected for an image capture signal displayed on a display unit, wherein, based on the characteristic of the mounted lens unit, the control unit performs control such that, with respect to the same operation amount of the movement operation on the operation unit, an amount of movement of the position of the AF frame is different depending on whether the mounted lens unit is a lens unit having a first characteristic in which a projection method of a lens is equidistant projection or the mounted lens unit is a lens unit having a second characteristic in which a projection method of a lens is central projection.

Still another aspect of the present disclosure provides an image capturing apparatus on which a lens unit is mountable, comprising: an acquisition unit configured to acquire a characteristic of a mounted lens unit; an operation unit configured to receive a movement operation; and a control unit configured to control, in accordance with the movement operation on the operation unit, a position of an AF frame indicating a region in which a defocus amount is to be detected for an image capture signal displayed on a display unit, wherein, based on the characteristic of the mounted lens unit, the control unit performs control such that, with respect to the same operation amount of the movement operation on the operation unit, an amount of movement of the position of the AF frame is different depending on whether the mounted lens unit is a lens unit having a first characteristic in which a type of a lens is a fisheye lens or the mounted lens unit is a lens unit having a second characteristic in which a type of a lens is not a fisheye lens.

Yet another aspect of the present disclosure provides a control method for an image capturing apparatus on which a lens unit is mountable, the method comprising: acquiring, by an acquisition unit, a characteristic of a mounted lens unit; receiving, by an operation unit, a movement operation; and controlling, in accordance with the movement operation on the operation unit, a position of an AF frame indicating a region in which a defocus amount is to be detected for an image capture signal displayed on a display unit, wherein in the controlling, based on the characteristic of the mounted lens unit, control is performed such that, in accordance with the same operation amount of the movement operation on the operation unit, an amount of movement of the position of the AF frame is different depending on whether the mounted lens unit is a lens unit having a first characteristic of having an imaging optical system with one optical axis or a lens unit having a second characteristic of having a plurality of imaging optical systems with different optical axes.

Still another aspect of the present disclosure provides a storage medium including a program for causing a computer to execute a control method for an image capturing apparatus on which a lens unit is mountable, the method comprising: acquiring a characteristic of the mounted lens unit; receiving a movement operation; and controlling, in accordance with the movement operation on the operation unit, a position of an AF frame indicating a region in which a defocus amount is to be detected for an image capture signal displayed on a display unit, wherein in the controlling, based on the characteristic of the mounted lens unit, control is performed such that, with respect to the same operation amount of the movement operation of the operation unit, an amount of movement of the position of the AF frame is different depending on whether the mounted lens unit is a lens unit having a first characteristic of having an imaging optical system with one optical axis or a lens unit having a second characteristic of having a plurality of imaging optical systems with different optical axes.

According to the present invention, it is possible to move an AF frame to a desired position within a screen even in a case where lens units with different characteristics are used.

Further features of the present invention will become apparent from the following description of exemplary embodiments (with reference to the attached drawings).

### BRIEF DESCRIPTION OF THE DRAWINGS

FIGS. 1A and 1B are diagrams showing an example of an external configuration of a camera serving as an example of an image capturing apparatus according to Embodiment 1.

FIG. 2 is a diagram showing an example of an internal configuration of a camera on which a single lens unit is mounted, the lens unit serving as an example of a lens unit according to Embodiment 1.

FIG. 3 is a schematic diagram showing an example of a configuration of a twin lens unit serving as an example of a lens unit according to Embodiment 1.

FIG. 4 is a schematic diagram showing an example of a pixel array of an image capture element in an image capture unit according to Embodiment 1.

FIG. 5 is a diagram showing a display example of a live view image in a camera in which the twin lens unit according to Embodiment 1 is mounted.

FIG. 6 is a flowchart showing AF frame movement control processing in Embodiment 1.

FIG. 7 is a flowchart showing AF frame movement control processing in Embodiment 2.

FIG. 8 is a flowchart showing AF frame movement control processing in Embodiment 3.

FIG. 9 is a flowchart showing AF frame movement control processing in Embodiment 4.

FIG. 10 is a flowchart showing AF frame movement control processing in Embodiment 5.

FIG. 11 is a flowchart showing AF frame movement control processing in Embodiment 6.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Embodiment 1

### External Configuration of Camera

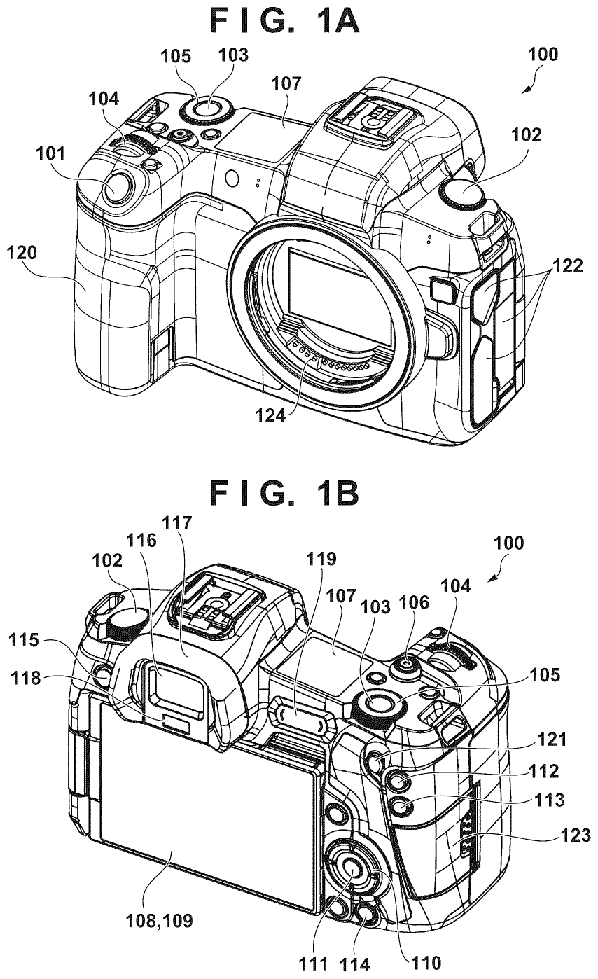

FIGS. 1A and 1B show an example of an external configuration of a digital camera (hereinafter simply referred to as a camera) 100 serving as an example of an image capturing apparatus according to this embodiment. Note that in the following description, a digital camera will be described as an example of an image capturing apparatus, but the movement control processing according to this embodiment, which will be described later, can also be applied to other electronic devices. These devices may include, for example, smartphones, game consoles, tablet terminals, personal computers, medical devices, surveillance cameras, and the like.

FIG. 1A is a perspective view of the camera 100 as viewed from the front, and FIG. 1B is a perspective view of the camera 100 as viewed from the back.

The camera 100 has, on its top surface, a shutter button 101, a power switch 102, a mode changeover switch 103, a main electronic dial 104, a sub electronic dial 105, a video button 106, and an outside-viewfinder display unit 107. The shutter button 101 is an operation unit for preparing to shoot or issuing an instruction to shoot. The power switch 102 is an operation unit for powering the camera 100 on and off. The mode changeover switch 103 is an operation unit for switching between various modes. The main electronic dial 104 is a rotary operation unit for changing setting values such as shutter speed and aperture. The sub electronic dial 105 is a rotary operation unit for moving a selection frame (cursor), advancing images, and the like. The video button 106 is an operation unit for issuing instructions to start and stop video shooting (recording). The outside-viewfinder display unit 107 displays various setting values such as shutter speed and aperture.

The camera 100 also has, on its back surface, a display unit 108, a touch panel 109, a direction key 110, a SET button 111, an AE lock button 112, an AF frame selection/enlargement button 113, a playback button 114, a menu button 115, an eyepiece portion 116, an eye proximity detection unit 118, and a touch bar 119. The display unit 108 displays images and various types of information. The touch panel 109 is an operation unit that detects a touch operation on a display surface (touch operation surface) of the display unit 108. The direction key 110 is an operation unit that is made up of a key that can be pressed up, down, left and right (a four-direction key). It is possible to perform an operation according to the position at which the direction key 110 is pressed. For example, the direction key 110 receives a movement operation to move the position of the AF frame according to a press of the key. The SET button 111 is an operation unit that is pressed mainly when determining a selection item. The AE lock button 112 is an operation unit that is pressed to fix an exposure state in a shooting standby state. The AF frame selection/enlargement button 113 is a shared operation unit for performing a selection operation that enables movement of the AF frame in a live view display (LV display) in the shooting mode, and is for switching an enlarged mode on and off. When the enlarged mode is on, the live view image (LV image) is enlarged or shrunk by operating the main electronic dial 104. Also, the AF frame selection/enlargement button 113 is used to enlarge a playback image or increase an enlargement ratio in playback mode. The playback button 114 is an operation unit for switching between a shooting mode and a playback mode. In the shooting mode, the playback mode is transitioned to by pressing the playback button 114, and the most recent image among images recorded on a later-described recording medium 229 can be displayed on the display unit 108.

The menu button 115 is an operation unit that is pressed to display a menu screen that allows various settings to be made, on the display unit 108. The user can intuitively perform various settings using the menu screen displayed on the display unit 108, the direction key 110, and the SET button 111. The eyepiece portion 116 is a portion for placing an eye close to an ocular viewfinder 117 (a look-in viewfinder). A user can view an image displayed on a later-described internal electronic viewfinder (EVF) 217 through the eyepiece portion 116. The eye proximity detection unit 118 is a sensor that detects whether or not the user's eye is near the eyepiece portion 116.

The touch bar 119 is a line-shaped touch operation unit (line touch sensor) capable of receiving a touch operation. The touch bar 119 is disposed at a position that can be touched by the thumb of the right hand when a grip portion 120 is gripped by the right hand (gripped with the little finger, ring finger, and middle finger of the right hand) such that the shutter button 101 can be pressed with the index finger of the right hand. That is, the touch bar 119 can be operated while the user's eye is near the eyepiece portion 116 and the user looks through the ocular viewfinder 117 and prepares to press the shutter button 101 at any time (shooting orientation). The touch bar 119 can receive a tap operation (operation of touching and then releasing without moving within a predetermined period of time) on the touch bar 119, slide operations to the left and right (operation of touching and then moving the touched position while still touching), and the like. The touch bar 119 is an operation portion different from the touch panel 109, and does not include a display function. The touch bar 119 receives a movement operation in accordance with the movement of the touch position for moving the position of the AF frame. The touch bar 119 of this embodiment is a multi-function bar, and functions as, for example, an M-Fn bar.

The camera 100 also has the grip portion 120, a thumb rest portion 121, a terminal cover 122, a lid 123, a communication terminal 124, and the like. The grip portion 120 is a holding portion formed in a shape that allows the user to easily hold the camera 100 with his or her right hand. The shutter button 101 and the main electronic dial 104 are arranged such that they can be operated with the index finger of the right hand with the camera 100 held by gripping the grip portion 120 with the little finger, ring finger, and middle finger of the right hand. In addition, the sub electronic dial 105 and the touch bar 119 are arranged at a position that can be operated with the thumb of the right hand in the same state. The thumb rest portion 121 (thumb standby position) is a grip portion provided on the rear side of the camera 100 at a position where the thumb of the right hand gripping the grip portion 120 can be easily placed when none of the operation portions are being operated. The thumb rest portion 121 is made of a rubber member or the like for improving holding power (grip sensation). The terminal cover 122 protects a connector such as a connection cable that connects the camera 100 to an external device. The lid 123 covers a slot for storing a later-described recording medium 229, thereby protecting the recording medium 229 and the slot. The communication terminal 124 is a terminal for communicating with a later-described lens unit 200 that can be attached to and detached from the camera 100.

### Internal Structure of Camera

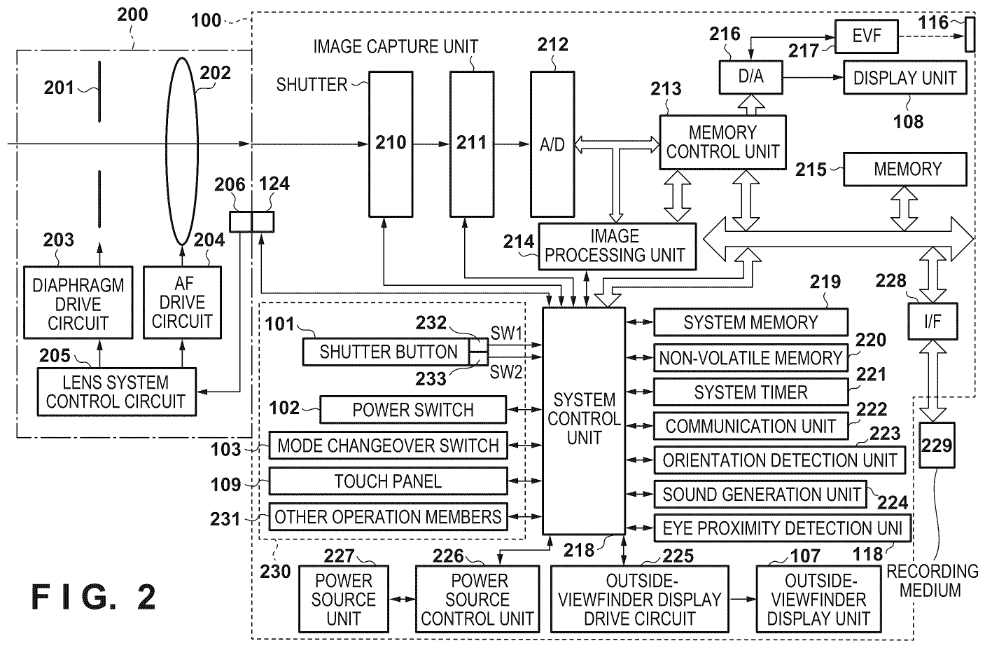

FIG. 2 shows an example of an internal configuration of the camera 100. Note that the same components as those in FIGS. 1A and 1B are denoted by the same reference numerals and description thereof is omitted as appropriate. The lens unit 200 is mounted on the camera 100.

First, the lens unit 200 will be described. The lens unit 200 is a type of interchangeable lens that can be attached to and detached from the camera 100. The lens unit 200 shown as an example in FIG. 2 is a single lens having an imaging optical system with one optical axis, and is an example of a normal lens.

The lens unit 200 includes a diaphragm 201, a lens 202, a diaphragm drive circuit 203, an autofocus (AF) drive circuit 204, a lens system control circuit 205, a communication terminal 206, and the like.

The diaphragm 201 is configured such that the opening diameter is adjustable. The lens 202 is constituted by a plurality of lenses. The diaphragm drive circuit 203 adjusts the amount of light by controlling the opening diameter of the diaphragm 201. The AF drive circuit 204 drives the lens 202 to adjust the focus. The lens system control circuit 205 controls the diaphragm drive circuit 203, the AF drive circuit 204, and the like, based on instructions from a system control unit 218, which will be described later. The lens system control circuit 205 controls the diaphragm 201 via the diaphragm drive circuit 203, and adjusts the focus by displacing the position of the lens 202 via the AF drive circuit 204. The lens system control circuit 205 is capable of communicating with the camera 100. Specifically, communication is performed via the communication terminal 206 of the lens unit 200 and the communication terminal 124 of the camera 100. The communication terminal 206 is a terminal through which the lens unit 200 communicates with the camera 100.

Next, the camera 100 will be described. The camera 100 has a shutter 210, an image capture unit 211, an A/D converter 212, a memory control unit 213, an image processing unit 214, a memory 215, a D/A converter 216, an EVF 217, a display unit 108, and a system control unit 218.

The shutter 210 is a focal plane shutter that can freely control the exposure time of the image capture unit 211 based on instructions from the system control unit 218. The image capture unit 211 is an image capture element (image sensor) constituted by a CCD, CMOS element, or the like, that converts an optical image into an electrical signal. The image capture unit 211 may have an image capture plane phase difference sensor that outputs defocus amount information to the system control unit 218. The A/D converter 212 converts the analog signal output from the image capture unit 211 into a digital signal. The image processing unit 214 performs predetermined processing (pixel interpolation, resizing processing such as reduction, color conversion, etc.) on the data from the A/D converter 212 or the data from the memory control unit 213. Also, the image processing unit 214 performs predetermined arithmetic processing using the shot image data, and the system control unit 218 performs exposure control and distance measurement control based on the obtained arithmetic result. As a result of this processing, through-the-lens (TTL) AF processing, automatic exposure (AE) processing, flash pre-emission (EF) processing, and the like are performed. Furthermore, the image processing unit 214 performs predetermined arithmetic processing using the shot image data, and performs TTL auto-white balance (AWB) processing based on the obtained computation result.

The image data from the A/D converter 212 is written into the memory 215 via the image processing unit 214 and the memory control unit 213. Alternatively, the image data from the A/D converter 212 is written into the memory 215 via the memory control unit 213 without passing through the image processing unit 214. The memory 215 stores image data obtained by the image capture unit 211 and converted into digital data by the A/D converter 212, as well as image data to be displayed on the display unit 108 and the EVF 217. The memory 215 has a storage capacity sufficient to store a predetermined number of still images and a predetermined amount of time of moving images and audio. The memory 215 also serves as a memory for image display (video memory).

The D/A converter 216 converts the image display data stored in the memory 215 into an analog signal and supplies the result to the display unit 108 or the EVF 217. Accordingly, the image data for display written in the memory 215 is displayed on the display unit 108 or the EVF 217 via the D/A converter 216. The display unit 108 and the EVF 217 perform display according to the analog signal from the D/A converter 216. The display unit 108 and the EVF 217 are, for example, displays such as an LCD or an organic EL display. After being subjected to A/D conversion by the A/D converter 212 and stored in the memory 215, the resulting digital signal is converted to an analog signal by the D/A converter 216, and the resulting analog signal is sequentially transferred to and displayed on the display unit 108 or the EVF 217, whereby live view display is performed.

The system control unit 218 is a control unit that is made up of at least one processor and/or at least one circuit. That is, the system control unit 218 may be a processor, a circuit, or a combination of a processor and a circuit. The system control unit 218 controls the entire camera 100. The system control unit 218 executes a program recorded in the non-volatile memory 220 to realize, for example, control processing for moving an AF frame, which will be described later. The system control unit 218 also performs display control by controlling the memory 215, the D/A converter 216, the display unit 108, the EVF 217, and the like.

The camera 100 also includes a system memory 219, a non-volatile memory 220, a system timer 221, a communication unit 222, an orientation detection unit 223, and the eye proximity detection unit 118.

The system memory 219 is, for example, a RAM. Constants and variables for the operation of the system control unit 218, programs read from the non-volatile memory 220, and the like are deployed in the system memory 219. The non-volatile memory 220 is an electrically erasable and recordable memory, and may be, for example, an EEPROM. In the non-volatile memory 220, constants, programs, and the like for the operation of the system control unit 218 are recorded. A program includes commands for executing control processing for moving the AF frame, which will be described later. The system timer 221 is a timing unit that measures the amount of time used for various controls and the time of a built-in clock. The communication unit 222 transmits and receives video and audio signals to and from an external device connected wirelessly or via a cable. The communication unit 222 can also be connected to a wireless local area network (LAN) and the Internet. The communication unit 222 can also communicate with an external device using Bluetooth (registered trademark) or Bluetooth Low Energy. The communication unit 222 can transmit images (including live images) shot by the image capture unit 211 and images recorded on the recording medium 229, and can receive image data and various other types of information from an external device. The orientation detection unit 223 detects the orientation of the camera 100 with respect to the direction of gravity. Based on the orientation detected by the orientation detection unit 223, it is possible to determine whether the image shot by the image capture unit 211 was shot with the camera 100 held horizontally or vertically. The system control unit 218 can add orientation information corresponding to the orientation detected by the orientation detection unit 223 to the image file of the image shot by the image capture unit 211, and can rotate and record the image. The orientation detection unit 223 may use, for example, an acceleration sensor or a gyrosensor. The orientation detection unit 223 can also be used to detect the movement of the camera 100 (panning, tilting, lifting, whether or not it is stationary, etc.). The sound generation unit 224 is capable of generating sounds in response to signals from the system control unit 218. For example, the sound generation unit 224 can generate effect sounds for when operating the camera 100, notification sounds for the AF focus state, audio for shot videos, and the like.

The eye proximity detection unit 118 can detect the approach of some object to the eyepiece portion 116 of the ocular viewfinder 117 in which the EVF 217 is incorporated. The eye proximity detection unit 118 may be, for example, an infrared proximity sensor. When an object is near, infrared light projected from a light projection portion of the eye proximity detection unit 118 is reflected by the object and received by a light receiving portion of the infrared proximity sensor. The distance from the eyepiece portion 116 to the object can be determined based on the amount of infrared light received. In this manner, the eye proximity detection unit 118 performs eye proximity detection to detect the object being near to or away from the eyepiece portion 116. The eye proximity detection unit 118 is an eye proximity detection sensor that detects that an eye (object) is near (eye proximity) and that an eye (object) is away (eye departure) with respect to the eyepiece portion 116 of the ocular viewfinder 117. When an object at a predetermined distance or less from the eyepiece portion 116 is detected from a non-eye-proximity state (non-proximity state), it is detected that the eye is near. On the other hand, if the object whose approach was detected moves away to a predetermined distance or more from the eye proximity state (proximity state), it is detected that the eye is away. The threshold value for detecting that the eye is near and the threshold value for detecting that the eye is away may be different, for example, by providing a hysteresis. After it is detected that the eye is near, the eye proximity state is maintained until it is detected that the eye is away. After detecting that the eye is away, the camera remains in the non-eye-proximity state until it is detected that the eye is near. The system control unit 218 switches the display unit 108 and the EVF 217 between display (display state) and non-display (non-display state) depending on the state detected by the eye proximity detection unit 118. Specifically, at least in a shooting standby state, when the display destination switching setting is automatic switching, the display is turned on with the display destination set to the display unit 108, and the EVF 217 is not displayed while the eye is away. While the eye is near, display is turned on with the display destination set to the EVF 217, and the display unit 108 is turned off. Note that the eye proximity detection unit 118 is not limited to an infrared proximity sensor, and other sensors may also be used as long as they can detect a state that can be regarded as the eye being near.

The camera 100 also has the outside-viewfinder display unit 107, an outside-viewfinder display drive circuit 225, a power source control unit 226, a power source unit 227, a recording medium I/F 228, an operation unit 230, and the like.

The outside-viewfinder display unit 107 displays various setting values of the camera 100 such as the shutter speed and aperture via the outside-viewfinder display drive circuit 225. The power source control unit 226 is constituted by a battery detection circuit, a DC-DC converter, a switch circuit for switching between blocks to which current is to be applied, and the like, performs detection of whether or not a battery is mounted, the type of battery, and the remaining battery level, and the like. Also, the power source control unit 226 controls a DC-DC converter based on the detection result and instructions from the system control unit 218, and supplies the necessary voltage to each unit including the recording medium 229 for the necessary period. The power source unit 227 is a primary battery such as an alkaline battery or a lithium battery, a secondary battery such as a NiCd battery, a NiMH battery or a Li battery, an AC adapter, or the like. The recording medium I/F 228 is an interface with the recording medium 229 such as a memory card or a hard disk. The recording medium 229 is a memory card or the like for recording shot images, and is constituted by a semiconductor memory, a magnetic disk, or the like. The recording medium 229 may be removable or may be built-in.

The operation unit 230 is an input unit that receives operations from the user (user operations), and is used to input various instructions to the system control unit 218. The operation unit 230 includes the shutter button 101, the power switch 102, the mode changeover switch 103, the touch panel 109, other operation members 231, and the like. The other operation members 231 include the main electronic dial 104, the sub electronic dial 105, the video button 106, the direction key 110, the SET button 111, the AE lock button 112, the AF frame selection/enlargement button 113, the playback button 114, the menu button 115, the touch bar 119, and the like.

The shutter button 101 has a first shutter switch 232 and a second shutter switch 233. The first shutter switch 232 is turned on by partial operation of the shutter button 101, that is, by a so-called half-press (a shooting preparation instruction), and generates a first shutter switch signal SW1. In response to the first shutter switch signal SW1, the system control unit 218 starts shooting preparation processing such as AF processing, AE processing, AWB processing, and EF processing. The second shutter switch 233 is turned on by complete operation of the shutter button 101, that is, by a so-called full-press (shooting instruction), and generates a second shutter switch signal SW2. In response to the second shutter switch signal SW2, the system control unit 218 starts a series of image capture processes, from reading out a signal from the image capture unit 211 to generating an image file including the shot image and writing it in the recording medium 229.

The mode changeover switch 103 switches the operation mode of the system control unit 218 to one of a still image shooting mode, a video shooting mode, a playback mode, and the like. The still image shooting mode includes an auto shooting mode, an auto scene determination mode, a manual mode, an aperture priority mode (Av mode), a shutter speed priority mode (Tv mode), and a program AE mode (P mode). There are also various scene modes, custom modes, and the like that are shooting settings for different shooting scenes. The user can directly switch to any of the above-mentioned shooting modes by using the mode changeover switch 103. Alternatively, the user can use the mode changeover switch 103 to switch to a screen showing a list of shooting modes, and then use the operation unit 230 to selectively switch to any one of the displayed plurality of modes. Similarly, the video shooting mode may also include a plurality of modes.

The touch panel 109 is a touch sensor that detects various touch operations on the display surface of the display unit 108 (the operation surface of the touch panel 109). The touch panel 109 and the display unit 108 can be formed integrally. For example, the touch panel 109 is attached to the upper layer of the display surface of the display unit 108 such that the light transmittance does not interfere with the display of the display unit 108. Then, by associating input coordinates on the touch panel 109 with display coordinates on the display surface of the display unit 108, a graphical user interface (GUI) can be constructed that makes it appear as if the user is directly operating the screen displayed on the display unit 108. The touch panel 109 can use any of various methods, such as a resistive film method, a capacitive method, a surface acoustic wave method, an infrared method, an electromagnetic induction method, an image recognition method, and an optical sensor method. Depending on the method, there is a method that detects that a touch has occurred due to contact with the touch panel 109 having occurred, or a method that detects that a touch has occurred due to the approach of a finger or a pen to the touch panel 109 having occurred, but either method is acceptable.

The system control unit 218 can detect the following operations or states on the touch panel 109:
A finger or pen that has not been touching the touch panel 109 touching the touch panel 109 again, that is, the start of touching (hereinafter referred to as a “touch-down”).
A state in which the touch panel 109 is being touched with a finger or a pen (hereinafter referred to as a “touch-on”).
The touch panel 109 being moved while being touched with a finger or a pen (hereinafter referred to as a “touch-move”).
A finger or pen that has been touching the touch panel 109 being removed (released) from the touch panel 109, that is, the termination of touch (hereinafter referred to as a “touch-up”).
A state in which nothing is being touched on the touch panel 109 (hereinafter referred to as a “touch-off”).

When a touch-down is detected, a touch-on is also detected at the same time. After a touch-down, a touch-on will normally continue to be detected unless a touch-up is detected. When a touch-move is detected, a touch-on is also detected at the same time. Even if a touch-on is detected, a touch-move is not detected unless the touch position moves. After it is detected that all fingers or pens that were touching the screen have performed a touch-up, a touch-off occurs.

These operations and states, as well as the coordinates of the position on the touch panel 109 touched by the finger or pen, are notified to the system control unit 218 via an internal bus. The system control unit 218 judges what kind of operation (touch operation) has been performed on the touch panel 109 based on the notified information. Regarding the touch-move, the movement direction of the finger or pen moving on the touch panel 109 can also be judged for each vertical and horizontal component on the touch panel 109 based on the change in position coordinates. When a touch-move of a predetermined distance or more is detected, it is judged that a slide operation has been performed. An operation of touching the touch panel 109 with a finger, moving the finger quickly by a certain distance, and then releasing the finger is called a flick. In other words, a flick is an operation of quickly tracing the touch panel 109 with a finger in a flicking motion. When a touch-move is detected for a predetermined distance or more at a predetermined speed or more, and then a touch-up is detected immediately thereafter, it is judged that a flick has been performed (it can be judged that a flick has occurred following a slide operation). Furthermore, a touch operation in which a plurality of points (e.g., two points) are touched together (multi-touched) and the touch positions are brought closer together is called a pinch-in, and a touch operation in which the touch positions are moved away from each other is called a pinch-out. A pinch-out and a pinch-in are collectively called pinch operations (or simply pinches).

### Lens Unit Configuration

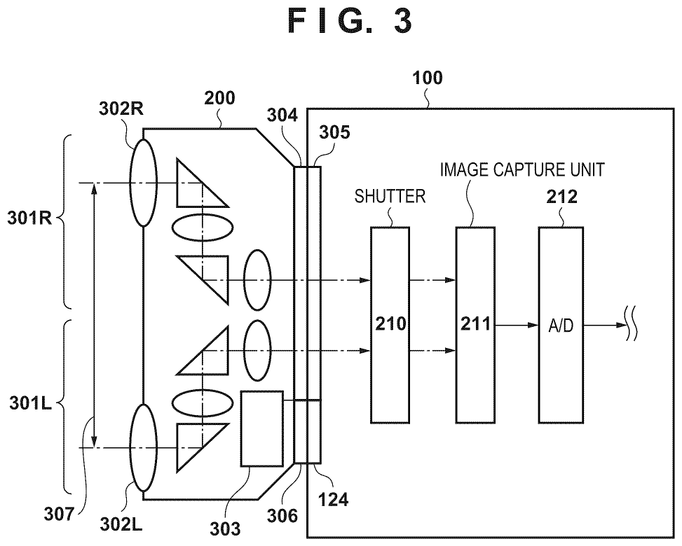

FIG. 3 schematically shows an example of a configuration of a lens unit 300. FIG. 3 shows a state in which the lens unit 300 is mounted on the camera 100. Note that in the camera 100 shown in FIG. 3, the same components as those described in FIG. 2 are denoted by the same reference numerals, and description thereof is omitted as appropriate.

The lens unit 300 is a type of interchangeable lens that can be attached to and detached from the camera 100. The lens unit 300 is a twin lens capable of shooting a left image and a right image with parallax. The lens unit 300 has two optical systems, each of which has a wide viewing angle of approximately 180 degrees and can shoot an image in a frontward hemispherical range. Specifically, the two optical systems of the lens unit 300 can each shoot a subject with a field of view (angle of view) of 180 degrees in the left-right direction (horizontal angle, azimuth angle, yaw angle) and 180 degrees in the up-down direction (vertical angle, elevation angle, pitch angle).

The lens unit 300 includes a right-eye optical system 301R having a plurality of lenses, a reflecting mirror, and the like, a left-eye optical system 301L having a plurality of lenses, a reflecting mirror, and the like, and a lens system control circuit 303. The right-eye optical system 301R corresponds to an example of a first optical system, and the left-eye optical system 301L corresponds to an example of a second optical system. The right-eye optical system 301R and the left-eye optical system 301L respectively have lenses 302R and 302L arranged on the subject side, which face in the same direction and have optical axes approximately parallel to each other. An inter-optical axis distance 307 is the distance between the optical axes of the left-eye optical system 301L and the right-eye optical system 301R. The lens unit 200 of this embodiment is a VR180 lens for shooting images for so-called VR180, which is a VR image format that allows twin-lens stereoscopic viewing. The VR180 lens has lenses that enable the right-eye optical system 301R and the left-eye optical system 301L to capture a range of approximately 180 degrees. Note that the VR180 lens may also be a lens that can capture an image that allows the right-eye optical system 301R and the left-eye optical system 301L to acquire video images capable of twin-lens VR display in VR180, and that can capture a wide viewing angle range of about 160 degrees, which is narrower than the range of 180 degrees. The VR180 lens can form a right image (first image) formed via the right-eye optical system 301R and a left image (second image) formed via the left-eye optical system 301L, which has parallax with respect to the right image, on one or two image capture elements of the camera on which it is mounted. Similarly to the lens unit 200, the lens unit 300 includes a diaphragm drive circuit and an AF drive circuit. Although not illustrated, there are two AF drive circuits, namely an AF drive circuit that drives the lens of the right image formed via the right-eye optical system 301R to adjust the focus, and an AF drive circuit that drives the lens of the left image formed via the left-eye optical system 301L to adjust the focus. The AF drive circuits can also simultaneously drive the lenses of the right image formed via the right-eye optical system 301R and the left image formed via the left-eye optical system 301L to adjust the focus.

Also, the lens unit 300 is mounted on the camera 100 via a lens mount portion 304 and a camera mount portion 305 of the camera 100. When the lens unit 300 is mounted on the camera 100, the system control unit 218 of the camera 100 and the lens system control circuit 303 of the lens unit 300 are electrically connected to each other via the communication terminal 124 of the camera 100 and the communication terminal 306 of the lens unit 300.

In this embodiment, a right image formed via the right-eye optical system 301R and a left image formed via the left-eye optical system 301L having parallax with respect to the right image are formed side by side on the image capture unit 211 of the camera 100. That is, two optical images formed by the right-eye optical system 301R and the left-eye optical system 301L are formed on one image capture element. The image capture unit 211 converts the formed subject image (optical signal) into an analog electrical signal. In this way, by using the lens unit 300, two images with parallax can be acquired at the same time (as a set) from two locations (optical systems), namely the right-eye optical system 301R and the left-eye optical system 301L. Also, by dividing the acquired image into an image for the left eye and an image for the right eye and displaying them in VR, the user can view a stereoscopic VR image with a range of approximately 180 degrees, that is, a so-called VR180.

Here, a VR image is an image that can be displayed in VR, as described later. VR images include omnidirectional images (spherical images) shot with an omnidirectional camera (spherical camera), panoramic images that have a wider image range (effective image range) than the display range that can be displayed at one time on a display unit, and the like. In addition, VR images are not limited to still images, but also include videos and live images (images obtained from a camera in approximately real time). VR images have a maximum imaging range (effective imaging range) of 360 degrees in the left-right direction and 360 degrees in the up-down direction. VR images also include images that have a wider angle of view than can be shot by a normal camera, or a wider imaging range than can be displayed at one time on a display unit, even if the angle is less than 360 degrees in the left-right direction and less than 360 degrees in the up-down direction. An image captured by the camera 100 using the lens unit 300 described above is a type of VR image. VR images can be displayed in VR, for example, by setting the display mode of a display apparatus (a display apparatus capable of displaying VR images) to “VR view”. By displaying a VR image with a 360-degree angle of view in VR and changing the orientation of the display apparatus in the left-right direction (horizontal rotation direction), the user can view a seamless omnidirectional image in the left-right direction.

Here, VR display (VR view) refers to a display method (display mode) in which it is possible to change a display range of displaying, among VR images, an image with an angle-of-view range corresponding to the orientation of the display apparatus. VR display includes “single-lens VR display (single-lens VR view)”, in which a single image is displayed by performing a transformation (transformation that corrects distortion) that maps a VR image onto a virtual sphere. Also, VR display includes “twin-lens VR display (twin-lens VR view)”, in which a VR image for the left eye and a VR image for the right eye are displayed side by side in left and right regions after performing a transformation that respectively maps them onto virtual spheres. Stereoscopic vision is possible by performing “twin-lens VR display” using a VR image for the left eye and a VR image for the right eye, which have parallax between them. On any VR display, for example, when a user mounts a display device such as a head mounted display (HMD), an image with a field-of-view range corresponding to the direction of the user's face is displayed. For example, it is assumed that at a certain point in time, a VR image displays an image with a field-of-view range centered at 0 degrees in the left-right direction (a specific azimuth, e.g., north) and 90 degrees in the up-down direction (90 degrees from the zenith, i.e., horizontal). If the display apparatus is flipped over from this state (e.g., the display surface is changed from facing south to facing north), the display range will change to an image of the same VR image with a field of view centered at 180 degrees in the left-right direction (the opposite azimuth, e.g., south) and 90 degrees in the up-down direction. That is, when the user mounts the HMD and turns his or her face from north to south (i.e., turns to face the rear), the image displayed on the HMD also changes from an image facing north to an image facing south. Note that the VR image shot using the lens unit 300 of this embodiment is a VR180 image obtained by shooting a range of approximately 180 degrees frontward, and there is no image in a range of approximately 180 degrees rearward. When such a VR180 image is displayed in VR and the orientation of the display apparatus is changed to a side where there is no image, a blank region is displayed.

By performing VR display of VR images in this way, the user visually feels as if he or she is inside the VR image (inside a VR space). Note that the method for displaying a VR image is not limited to a method in which the orientation of the display device is changed. For example, the display range may be moved (scrolled) in accordance with a user operation performed via a touch panel, a direction button, or the like. In addition, during VR display (when the display mode is “VR view”), in addition to changing the display range due to a change in orientation, the display range may also be changed in accordance with a touch-move performed on a touch panel, a drag operation performed with a mouse, a press of a direction button, or the like. Note that a smartphone mounted on VR goggles (head-mounted adapter) is a type of HMD.

### Configuration of Image Capture Element in Image Capture Unit

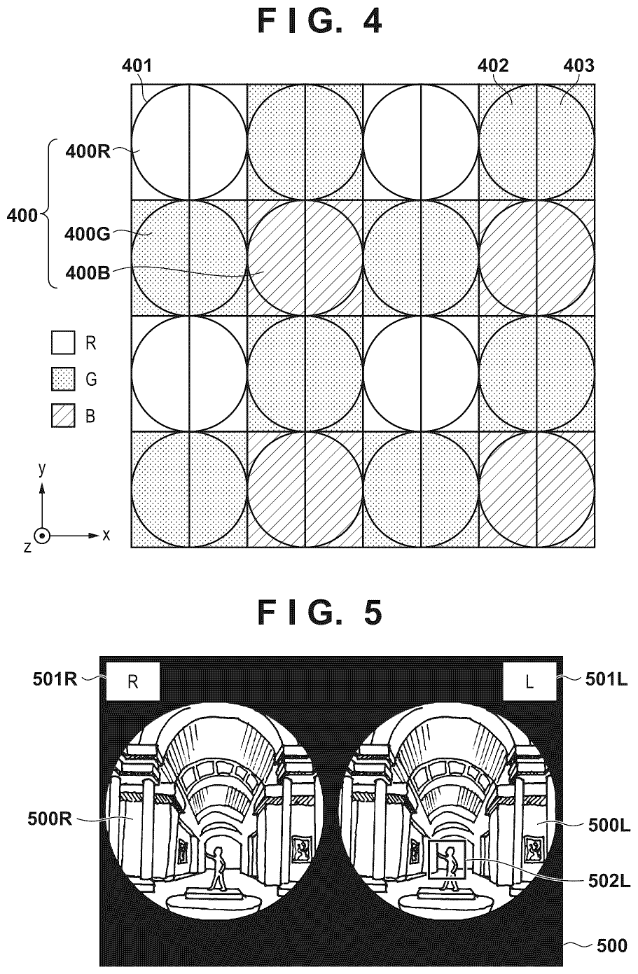

FIG. 4 shows an overview of a pixel array of the image capture element in the image capture unit 211 in this embodiment. FIG. 4 shows a pixel array of a two-dimensional CMOS sensor used as an image capture element in the image capture unit 211 in this embodiment, in a range of 4 columns×4 rows of image capture pixels (a range of 8 columns×4 rows of a focus detection pixel array).

In this embodiment, a pixel group 400 is made up of 2 columns×2 rows of pixels, and is covered with color filters in a Bayer array. In the pixel group 400, a pixel 400R having a spectral sensitivity of R (red) is disposed in an upper left position, pixels 400G having a spectral sensitivity of G (green) are arranged in upper right and lower left positions, and a pixel 400B having a spectral sensitivity of B (blue) is disposed in a lower right position. Furthermore, in the image capture element in the image capture unit 211 of this embodiment, each pixel holds a plurality of photodiodes (photoelectric conversion units) for one microlens 401 in order to perform focus detection using an image capture plane phase difference method. In this embodiment, each pixel is constituted by two photodiodes 402 and 403 arrayed in 2 columns×1 row.

The image capture element in the image capture unit 211 is capable of acquiring an image capture signal and a focusing signal due to a large number of pixel groups 400, each consisting of 2 columns×2 rows of pixels (4 columns×2 rows of photodiodes) as shown in FIG. 4, being arranged on the image capture plane.

In each pixel having such a configuration, a light beam is split by a microlens 401 and forms images on the photodiodes 402 and 403. A signal (signal A+B) obtained by adding together the signals from the two photodiodes 402 and 403 is used as an image capture signal, and two signals (image signals A and B) read out from each of the photodiodes 402 and 403 are used as focusing signals. Note that although the image capture signal and the focusing signals may be read out separately, the following method may be used in consideration of the processing load. That is, the image capture signal (signal A+B) and a focusing signal (e.g., signal A) of either one of the photodiodes 402 and 403 may be read out, and the difference may be found to acquire the other focusing signal (e.g., signal B).

Note that in this embodiment, each pixel has two photodiodes 402 and 403 for one microlens 401, but the number of photodiodes is not limited to two and may be more than two. In addition, a plurality of pixels, each of which has a light receiving portion with a different opening position, may be included with respect to the microlens 401. That is, any configuration may be used as long as it results in obtaining two signals for phase difference detection, such as an image signal A and an image signal B, which enable phase difference detection.

In addition, although FIG. 4 shows a configuration in which all pixels have a plurality of photodiodes, there is no limitation to this, and focus detection pixels as shown in FIG. 4 may be provided discretely within normal pixels that constitute the image capture element in the image capture unit 211.

### Example of Displaying Live View Image

FIG. 5 shows an example of a display on the display unit 108 that displays a live view image of the camera 100 when the twin lens unit is mounted. The left image formed via the left-eye optical system 301L of the lens unit 300 is displayed in the live view image 500 as a left image 500L, and the right image formed via the right-eye optical system 301R is displayed in the live view image 500 as a right image 500R. The image 501L from the left lens and the image 501R from the right lens are displayed reversed in the left-right direction compared to the live view image 500, and this is a UI display to prevent the user from misunderstanding. A left image AF area 502L, which is an AF frame, is a display frame indicating the position where AF is desired to be performed, and is displayed on the left image 500L. The user can move the position of the left image AF area 502L by performing a movement operation according to a press of the direction key 110 or a movement operation according to movement of the touch position on the touch bar 119. Upon receiving the movement operation, the system control unit 218 performs control processing for moving the AF frame, which will be described later, and controls the position of the left image AF area 502L in accordance with the movement operation.

### Example of Acquiring Lens Information

When the lens unit 200 is mounted on the camera 100, the camera 100 can acquire information on the lens unit 200 via the communication terminal 206 of the lens unit and the communication terminal 124 of the camera 100. The camera 100 acquires information indicating a characteristic of the mounted lens unit via the communication terminal 124 and the communication terminal 206. The information regarding the characteristic of the lens unit can include information indicating at least one of the configuration of the lens unit, the projection method of the lens, and the type of the lens. The information indicating the configuration of the lens unit includes, for example, information indicating whether the lens unit is a single lens or a twin lens. In addition, the information indicating the projection method of the lens includes, for example, information indicating whether the lens uses central projection or equidistant projection. Furthermore, the information indicating the type of the mounted lens includes, for example, information indicating whether or not the lens is a fisheye lens. The system control unit 218 controls the amount of movement of the position of the AF frame in accordance with the characteristic of the mounted lens unit in control processing for moving the AF frame, which will be described later.

### Series of Operations for AF Frame Movement Control Processing

Next, AF frame movement control processing according to this embodiment will be described. The AF frame movement control processing is processing for easily and accurately moving the AF frame to a desired position within the screen in a situation in which lens units with various characteristics can be mounted on the camera 100. In a case where lens units with different characteristics can be mounted, if the AF frame is moved uniformly in accordance with an operation of moving the AF frame (without taking into consideration the characteristic of the lens unit), it may not be possible to move the AF frame to the desired position within the screen. For example, in contrast to a single-lens display when a single lens with one optical system is mounted, in a twin-lens VR display in which a twin lens with two optical systems is mounted, moving the AF frame by the same amount within the screen will result in rough movement with respect to the subject. That is, with twin-lens VR display, there are cases where the user is unable to dispose the AF frame at a desired position on the screen with high accuracy. For this reason, in the AF frame movement control processing, based on the characteristic of the lens unit, control is performed such that the amount of movement of the AF frame is different, for example, depending on whether the mounted lens unit is a single lens or a twin lens.

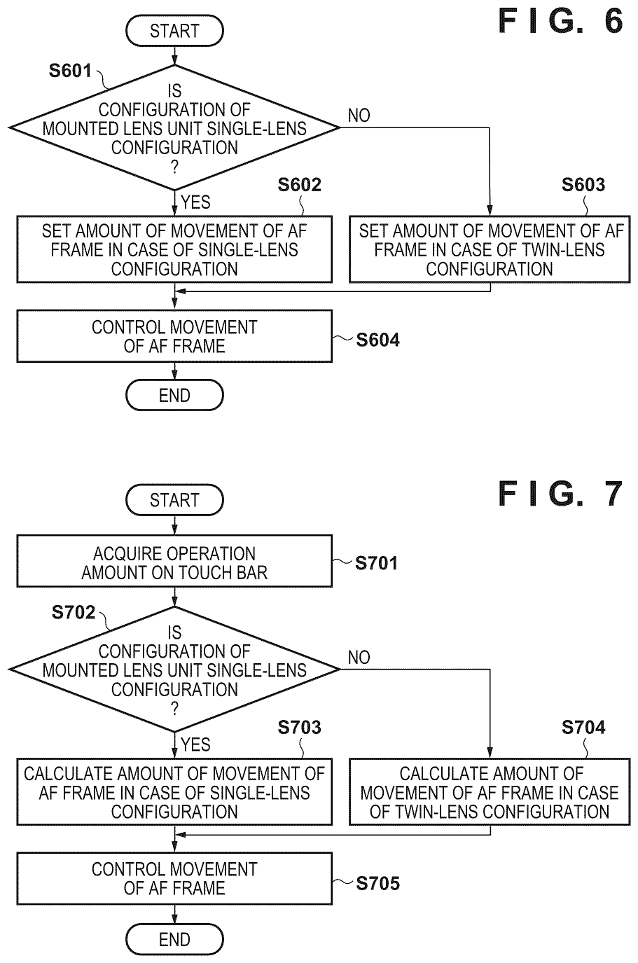

With reference to FIG. 6, an example will be described in which the AF frame movement control processing is used to perform control such that the amount of movement of the AF frame is different depending on whether the mounted lens unit is a single lens or a twin lens. Note that a series of operations in the AF frame movement control processing according to this embodiment is realized by the system control unit 218 executing a program recorded in the non-volatile memory 220. Also, this series of operations is started when the AF frame selection/enlargement button 113 is operated to enable movement of the AF frame in the LV display of the shooting mode, and the direction key 110 is operated.

In step S601, the system control unit 218 judges whether the configuration of the mounted lens unit is that of a single lens (single-lens configuration). The system control unit 218 can acquire information indicating the characteristic of the lens unit via the communication terminal 124 of the camera 100, and use this information to judge the configuration of the lens unit. If the configuration of the mounted lens unit is a single-lens configuration, the system control unit 218 advances the processing to step S602, and if not, the system control unit 218 advances the processing to step S603. Note that the system control unit 218 may judge in step S601 whether the configuration of the mounted lens unit is that of a multi-lens unit including a twin lens. In this case, if the lens unit has a multi-lens configuration, the processing may proceed to step S603, and if not, the processing may proceed to step S602.

In step S602, since the configuration of the mounted lens unit is a single-lens configuration, the system control unit 218 sets a predetermined movement amount as the movement amount of the AF frame in the case of a single lens. For example, the system control unit 218 sets the amount of movement of the AF frame in the case of a single lens to an amount of movement corresponding to one-third the size of the AF frame.

In step S603, since the configuration of the mounted lens unit is not a single lens (e.g., it is a twin lens), the system control unit 218 sets a predetermined movement amount as the movement amount of the AF frame in the case of a twin lens (or multi-lens). The system control unit 218 sets the amount of movement of the AF frame in the case of a twin lens to, for example, an amount of movement corresponding to one-sixth the size of the AF frame, which is half the amount of movement of the AF frame in the case of a single lens. That is, the system control unit 218 controls the amount of movement of the AF frame in the case of a twin lens to be half the amount of movement of the AF frame in the case of a single lens with respect to the same operation amount of a movement operation on the direction key 110. In step S604, the system control unit 218 moves the AF frame displayed on the display unit 108 according to the amount of movement of the AF frame set in step S602 or step S603. The system control unit 218 then terminates the series of operations.

In this manner, based on the characteristic of the mounted lens unit, the system control unit 218 causes the amount of movement of the position of the AF frame to be different depending on whether the mounted lens unit is a single lens or a twin lens, with respect to the same operation amount of a movement operation on the direction key 110. For example, the system control unit 218 controls the amount of movement of the AF frame in the case of a twin lens to be half the amount of movement of the AF frame in the case of a single lens, with respect to the same operation amount of a movement operation on the direction key 110. For this reason, even in twin-lens VR display in which a twin lens is mounted, the user can dispose the AF frame at a desired position within the screen with the same operational feel as when using a single lens.

### Embodiment 2

Next, Embodiment 2 will be described. Embodiment 2 differs from Embodiment 1 in that the movement of the position of the AF frame is controlled according to a movement operation on the touch bar 119. Accordingly, although the operation of the AF frame movement control processing differs from that in the above-described embodiment, the configurations of the above-described camera and lens unit are substantially the same as those in Embodiment 1. For this reason, the same or substantially the same configurations and processes are denoted by the same reference numbers and description thereof is omitted.

### Series of Operations for AF Frame Movement Control Processing

AF frame movement control processing according to Embodiment 2 will be described with reference to FIG. 7. Note that a series of operations in the AF frame movement control processing according to this embodiment is realized by the system control unit 218 executing a program recorded in the non-volatile memory 220. This series of operations is started when the AF frame selection/enlargement button 113 is operated and the AF frame can be moved in the LV display of the shooting mode.

In step S701, the system control unit 218 acquires a movement operation (e.g., a slide operation amount in the left-right direction) on the touch bar 119 by the user. In step S702, the system control unit 218 judges whether the configuration of the mounted lens unit is that of a single lens (single-lens configuration). The system control unit 218 can acquire information indicating the characteristic of the lens unit via the communication terminal 124 of the camera 100, and use this information to judge the configuration of the lens unit. If the configuration of the mounted lens unit is a single-lens configuration, the system control unit 218 advances the processing to step S703, and if not, the system control unit 218 advances the processing to step S704. Note that the system control unit 218 may judge in step S702 whether the configuration of the mounted lens unit is that of a multi-lens including a twin lens. In this case, if the camera has a multi-lens configuration, the processing may proceed to step S704, and if not, the processing may proceed to step S703.

In step S703, since the configuration of the mounted lens unit is a single lens, the system control unit 218 calculates a slide operation amount in the left-right direction acquired in step S701 as the movement amount of the AF frame in the case of a single lens. In step S704, the system control unit 218 calculates the amount of movement of the AF frame in the case where the mounted lens unit is a twin lens (or multi-lens), based on the slide operation amount acquired in step S701. The system control unit 218 sets, for example, half the amount of movement of the AF frame in the case where the mounted lens unit is a single lens as the amount of movement of the AF frame in the case where the mounted lens unit is a twin lens. In step S705, the system control unit 218 moves the AF frame displayed on the display unit 108 according to the amount of movement of the AF frame set in step S703 or step S704. The system control unit 218 then terminates the series of operations.

In this manner, based on the characteristic of the mounted lens unit, the system control unit 218 causes the amount of movement of the AF frame to be different depending on whether the mounted lens unit is a single lens or a twin lens, with respect to the same operation amount of a movement operation on the touch bar. For example, the system control unit 218 sets the amount of movement of the AF frame in the case of a twin lens to half the amount of movement of the AF frame in the case of a single lens with respect to the same operation amount of a movement operation on the touch bar. For this reason, even in twin-lens VR display in which a twin lens is mounted, the user can dispose the AF frame at a desired position within the screen with the same operational feel as when using a single lens.

### Embodiment 3

Next, Embodiment 3 will be described. Whether single lens or twin lens, there are lenses that use a central projection optical system and display an image in which the subject and the image are similar, and lenses that use an equidistant projection optical system and display an image in which the angle of incidence and image height are proportional, like fisheye lenses.

With a lens that uses equidistant projection, the display image is stretched when the image height increases compared to a lens that uses central projection, and therefore when the AF frame is moved by the same amount as in an image displayed with equidistant projection, the AF frame will move a shorter distance relative to the subject. That is, when using a lens unit with a lens whose projection method is equidistant projection, the user is faced with the problem of needing to perform additional operations when moving the AF frame to a desired position within the screen, compared to a case where the projection method is central projection.

Embodiment 3 differs from the above-described embodiments in that the movement of the position of the AF frame is controlled when a lens with a different projection method is mounted. Accordingly, although the operation of the AF frame movement control processing differs from that in the above-described embodiments, the configurations of the above-described camera and lens unit are substantially the same as those in Embodiment 1. For this reason, the same or substantially the same configurations and processes are denoted by the same reference numbers and description thereof is omitted.

### Series of Operations for AF Frame Movement Control Processing

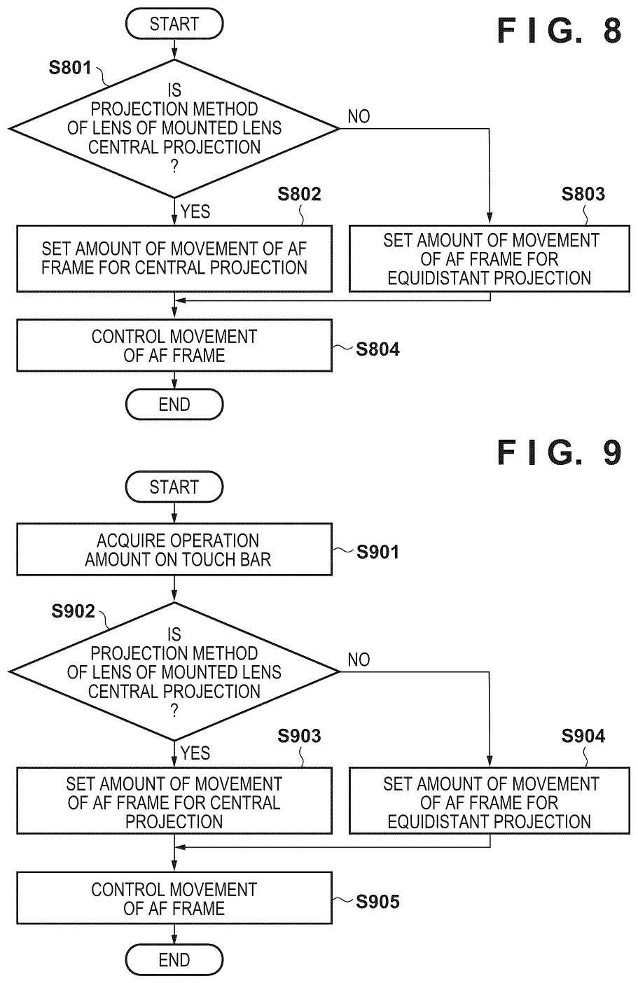

The AF frame movement control processing according to Embodiment 3 will be described with reference to FIG. 8. Note that a series of operations in the AF frame movement control processing according to this embodiment is realized by the system control unit 218 executing a program recorded in the non-volatile memory 220. Also, this series of operations is started when the AF frame selection/enlargement button 113 is operated to enable movement of the AF frame in the LV display of the shooting mode, and the direction key 110 is operated.

In step S801, the system control unit 218 judges whether the projection method of the lens of the mounted lens unit is central projection. The system control unit 218 can acquire information indicating the characteristics of the lens unit via the communication terminal 124 of the camera 100, and use this information to judge the projection method of the lens of the lens unit. If the projection method of the lens is central projection, the system control unit 218 advances the processing to step S802, and if not, the system control unit 218 advances the processing to step S803.

In step S802, since the projection method of the lens of the mounted lens unit is central projection, the system control unit 218 sets a predetermined movement amount as the movement amount of the AF frame in the case of central projection. For example, the system control unit 218 sets the amount of movement of the AF frame in the case where the projection method is central projection to, for example, a movement amount corresponding to one-third the size of the AF frame. The amount of movement of this AF frame may be the same as in the case of a single-lens configuration.

In step S803, since the projection method of the lens of the mounted lens unit is not central projection (e.g., it is equidistant projection), the system control unit 218 sets the movement amount of the AF frame in the case of equidistant projection. The system control unit 218 sets the amount of movement of the AF frame in the case where the projection method is equidistant projection to, for example, a movement amount corresponding to two-thirds the size of the AF frame, which is twice the amount of movement of the AF frame in central projection.

In step S804, the system control unit 218 moves the AF frame displayed on the display unit 108 according to the amount of movement of the AF frame set in step S802 or step S803. The system control unit 218 then terminates the series of operations.

In this manner, based on the characteristic of the mounted lens unit, the system control unit 218 causes the amount of movement of the position of the AF frame to be different depending on whether the mounted lens unit uses central projection or equidistant projection, with respect to the same operation amount of a movement operation on the direction key 110. For example, the system control unit 218 controls the amount of movement of the AF frame in the case of equidistant projection to be twice the amount of movement of the AF frame in the case of central projection with respect to the same operation amount of a movement operation on the direction key 110. For this reason, the user can dispose the AF frame at the desired position on the screen with the same operational feel, whether a lens whose projection method is central projection or a lens whose projection method is equidistant projection is mounted.

### Embodiment 4

Next, Embodiment 4 will be described. Embodiment 4 relates to the movement of the AF frame when lenses with different projection methods are mounted, but differs from Embodiment 3 in that the movement of the position of the AF frame is controlled in accordance with a movement operation on the touch bar 119. Accordingly, although the operation of the AF frame movement control processing differs from that in the above-described embodiments, the configurations of the above-described camera and lens unit are substantially the same as those in Embodiment 1. For this reason, the same or substantially the same configurations and processes are denoted by the same reference numbers and description thereof is omitted.

### Series of Operations for AF Frame Movement Control Processing

The AF frame movement control processing according to Embodiment 4 will be described with reference to FIG. 9. Note that a series of operations in the AF frame movement control processing according to this embodiment is realized by the system control unit 218 executing a program recorded in the non-volatile memory 220. This series of operations is started when the AF frame selection/enlargement button 113 is operated and the AF frame can be moved in the LV display of the shooting mode.

In step S901, the system control unit 218 acquires a movement operation (e.g., a slide operation amount to the left or right) on the touch bar 119 by the user. In step S902, the system control unit 218 judges whether the projection method of the lens of the mounted lens unit is central projection. The system control unit 218 can acquire information indicating the characteristic of the lens unit via the communication terminal 124 of the camera 100, and can use this information to judge the projection method of the lens of the lens unit. If the projection method of the lens is central projection, the system control unit 218 advances the processing to step S903, and if not, the system control unit 218 advances the processing to step S904. The system control unit 218 may judge whether the projection method of the lens is equidistant projection, and if the projection method of the lens is equidistant projection, the system control unit 218 may advance the processing to step S904, and if not, the system control unit 218 may advance the processing to step S903.

In step S903, because the projection method of the lens of the mounted lens unit is central projection, the system control unit 218 sets the slide operation amount to the left or right acquired in step S901 as the movement amount of the AF frame in the case of central projection.

In step S904, the system control unit 218 calculates the amount of movement of the AF frame based on the slide movement amount in the left-right direction acquired in step S901 since the projection method of the lens of the mounted lens unit is not central projection (e.g., it is equidistant projection). The system control unit 218 sets the amount of movement of the AF frame in the case where the projection method of the lens of the mounted lens unit is equidistant projection to, for example, twice the amount of movement of the AF frame in the case of central projection. In step S905, the system control unit 218 moves the AF frame displayed on the display unit 108 according to the amount of movement of the AF frame set in step S903 or step S904. The system control unit 218 then terminates the series of operations.

In this manner, based on the characteristic of the mounted lens unit, the system control unit 218 causes the amount of movement of the position of the AF frame to be different depending on whether the mounted lens unit uses central projection or equidistant projection, with respect to the same operation amount of a movement operation on the touch bar 119. For example, the system control unit 218 controls the amount of movement of the AF frame in the case of equidistant projection to be twice the amount of movement of the AF frame in the case of central projection, with respect to the same operation amount of a movement operation on the touch bar 119. For this reason, the user can dispose the AF frame at the desired position on the screen with the same operation feel, whether a lens whose projection method is central projection or a lens whose projection method is equidistant projection is mounted.

Note that the movement control processing according to Embodiments 3 and 4 may also be performed when the mounted lens unit is a single lens or a twin lens. That is, the lens unit in the case of central projection and the lens unit in the case of equidistant projection may each have a configuration including a plurality of imaging optical systems with different optical axes (that is, a twin-lens configuration).

In addition, if the projection method of the lens of the mounted lens unit is equidistant projection, the system control unit 218 may increase the amount of movement of the AF frame according to the image height (the angle of view on the image capture signal displayed on the display unit). In this way, the amount of movement of the AF frame can be changed according to the image height. On the other hand, the system control unit 218 may also be configured not to change the amount of movement of the AF frame according to the image height (the angle of view on the capture signal displayed on the display unit) if the projection method of the lens of the mounted lens unit is central projection.

### Embodiment 5

Next, Embodiment 5 will be described. In both single-lens and twin-lens cameras, there are cameras that use fisheye lenses and cameras that use normal lenses that are not fisheye lenses. When using a fisheye lens, the displayed image is stretched as the image height increases, resulting in the same problems as in the case of using the lens unit with equidistant projection described above in Embodiments 3 and 4. That is, there is a problem in that the user needs to perform an extra operation when moving the AF frame to a desired position within the screen.

Embodiment 5 differs from the above-described embodiments in that the movement of the position of the AF frame is controlled when using different types of lenses, such as a fisheye lens or the like. Accordingly, although the operation of the AF frame movement control processing differs from that in the above-described embodiments, the configurations of the above-described camera and lens unit are substantially the same as those in Embodiment 1. For this reason, the same or substantially the same configurations and processes are denoted by the same reference numbers and description thereof is omitted.

### Series of Operations for AF Frame Movement Control Processing

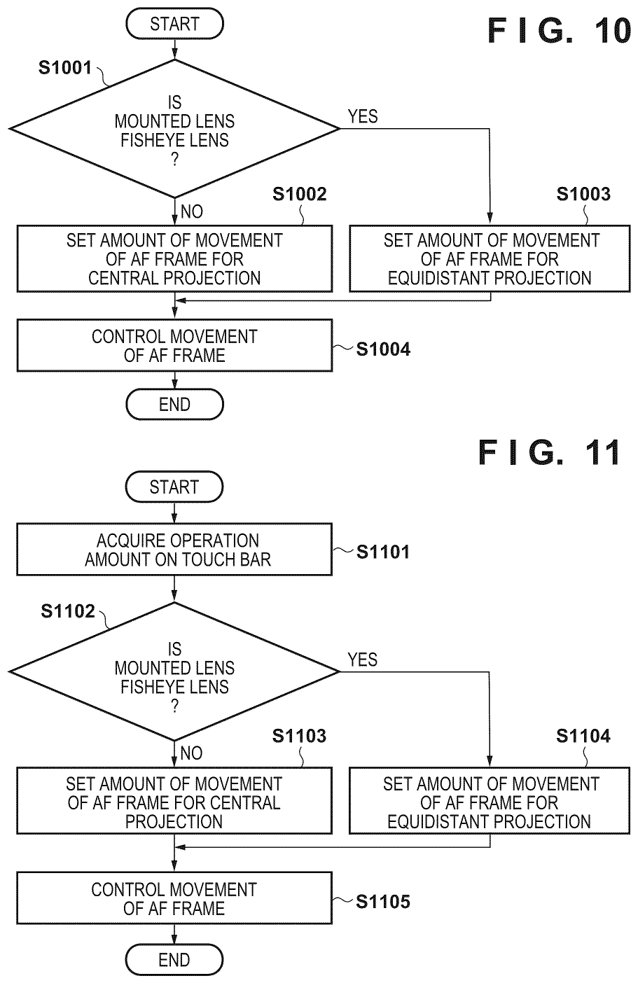

The AF frame movement control processing according to Embodiment 5 will be described with reference to FIG. 10. Note that a series of operations in the AF frame movement control processing according to this embodiment is realized by the system control unit 218 executing a program recorded in the non-volatile memory 220. Also, this series of operations is started when the AF frame selection/enlargement button 113 is operated to enable movement of the AF frame in the LV display of the shooting mode, and the direction key 110 is operated.

In step S1001, the system control unit 218 judges whether the lens type of the mounted lens unit is a fisheye lens. The system control unit 218 can acquire information indicating the characteristic of the lens of the lens unit via the communication terminal 124 of the camera 100, and can use this information to judge the type of the lens of the lens unit. If the type of lens is a fisheye lens, the system control unit 218 advances the processing to step S1003, and if not, the system control unit 218 advances the processing to step S1002.

In step S1002, the system control unit 218 sets the amount of movement of the AF frame in the case where the type of the lens of the mounted lens unit is not a fisheye lens (this may also be the amount of movement for central projection), since the type of the lens of the mounted lens unit is not a fisheye lens. For example, the system control unit 218 sets the amount of movement of the AF frame to, for example, an amount of movement corresponding to one-third the size of the AF frame as the amount of movement of the AF frame in the case where the type of the lens is not a fisheye lens. The amount of movement of this AF frame may be the same as in the case of a single-lens configuration.

In step S1003, since the type of lens in the mounted lens unit is a fisheye lens, the system control unit 218 sets the amount of movement of the AF frame in the case where the lens is a fisheye lens (which may also be the amount of movement for equidistant projection). The system control unit 218 sets the amount of movement of the AF frame in the case where the lens type is a fisheye lens to, for example, an amount of movement corresponding to two-thirds the size of the AF frame, which is twice the amount of movement of the AF frame in the case where the lens is not a fisheye lens (in the case of central projection). In step S1004, the system control unit 218 moves the AF frame displayed on the display unit 108, according to the amount of movement of the AF frame set in step S1002 and step S1003. The system control unit 218 then terminates the series of operations.

In this manner, based on the characteristic of the mounted lens unit, the system control unit 218 causes the amount of movement of the position of the AF frame to be different depending on whether or not the type of the lens is a fisheye lens, with respect to the same operation amount of a movement operation on the direction key 110. For example, the system control unit 218 controls the amount of movement of the AF frame in the case where the lens is a fisheye lens to be twice the amount of movement of the AF frame in the case where the lens is not a fisheye lens, with respect to the same operation amount of a movement operation on the direction key 110. For this reason, the user can dispose the AF frame at a desired position within the screen with the same operational feel whether a fisheye lens or a normal lens that is not a fisheye lens is used.

### Embodiment 6

Embodiment 6 relates to the movement of the position of the AF frame in the case of using different types of lenses, such as a fisheye lens or the like, but differs from Embodiment 5 in that the movement of the position of the AF frame is controlled in accordance with a movement operation on the touch bar 119. Accordingly, although the operation of the AF frame movement control processing differs from that in the above-described embodiments, the configurations of the above-described camera and lens unit are substantially the same as those in Embodiment 1. For this reason, the same or substantially the same configurations and processes are denoted by the same reference numbers and description thereof is omitted.

### Series of Operations for AF Frame Movement Control Processing

The AF frame movement control processing according to Embodiment 6 will be described with reference to FIG. 11. Note that a series of operations in the AF frame movement control processing according to this embodiment is realized by the system control unit 218 executing a program recorded in the non-volatile memory 220. This series of operations is started when the AF frame selection/enlargement button 113 is operated and the AF frame can be moved in the LV display of the shooting mode.

In step S1101, the system control unit 218 acquires a movement operation (e.g., a slide operation amount to the left or right) on the touch bar 119 by the user. In step S1102, the system control unit 218 judges whether the type of lens of the mounted lens unit is a fisheye lens. The system control unit 218 can acquire information indicating the characteristic of the lens unit via the communication terminal 124 of the camera 100, and can use this information to judge the type of the lens of the lens unit. If the type of lens is a fisheye lens, the system control unit 218 advances the processing to step S1104, and if not, the system control unit 218 advances the processing to step S1103.

In step S1103, since the type of lens of the mounted lens unit is not a fisheye lens, the system control unit 218 sets the slide operation amount in the left-right direction acquired in step S1101 as the movement amount of the AF frame in the case of a non-fisheye lens. The amount of movement of the AF frame may be the amount of movement for central projection.

In step S1104, since the type of the lens of the mounted lens unit is a fisheye lens, the system control unit 218 calculates the amount of movement of the AF frame from the amount of slide movement in the left-right direction acquired in step S1101. The system control unit 218 sets the amount of movement of the AF frame in the case where the type of the lens of the mounted lens unit is a fisheye lens to, for example, twice the amount of movement of the AF frame in the case where the type of the lens is not a fisheye lens (which may be the amount of movement in the case of equidistant projection). In step S1105, the system control unit 218 moves the AF frame displayed on the display unit 108 according to the amount of movement of the AF frame set in step S1103 or step S1104. The system control unit 218 then terminates the series of operations.

In this manner, based on the characteristic of the mounted lens unit, the system control unit 218 causes the amount of movement of the position of the AF frame to be different depending on whether or not the type of the lens is a fisheye lens, with respect to the same operation amount of a movement operation on the touch bar 119. For example, the system control unit 218 controls the amount of movement of the AF frame in the case where the lens is a fisheye lens to be twice the amount of movement of the AF frame in the case where the lens is not a fisheye lens, with respect to the same operation amount of a movement operation on the touch bar 119. For this reason, the user can dispose the AF frame at a desired position within the screen with the same operational feel, whether a fisheye lens or a normal lens that is not a fisheye lens is used.

Note that the movement control processing according to Embodiments 5 and 6 may be performed when the mounted lens unit is a single lens or a twin lens. That is, the lens unit in the case of a fisheye lens and the lens unit in the case of a non-fisheye lens may each have a configuration including a plurality of imaging optical systems with different optical axes (that is, a twin-lens configuration).

In addition, if the type of lens in the mounted lens unit is a fisheye lens, the system control unit 218 may increase the amount of movement of the AF frame according to the image height (the angle of view on the capture signal displayed on the display unit). In this way, the amount of movement of the AF frame can be changed according to the image height. On the other hand, if the type of lens in the mounted lens unit is not a fisheye lens (i.e., a central projection lens), the system control unit 218 may be configured not to change the amount of movement of the AF frame according to the image height (the angle of view on the capture signal displayed on the display unit).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-015049, filed Feb. 2, 2024 which is hereby incorporated by reference herein in its entirety.

What is claimed is:

1. An image capturing apparatus on which a lens unit is mountable, comprising:
an acquisition unit configured to acquire a characteristic of a mounted lens unit;
an operation unit configured to receive a movement operation; and
a control unit configured to control, in accordance with the movement operation on the operation unit, a position of an AF frame indicating a region in which a defocus amount is to be detected for an image capture signal displayed on a display unit,
wherein, based on the characteristic of the mounted lens unit, the control unit performs control such that, with respect to the same movement amount of the movement operation on the operation unit, an amount of movement of the position of the AF frame is different depending on whether the mounted lens unit is a lens unit having a first characteristic of having an imaging optical system with one optical axis or a lens unit having a second characteristic of having a plurality of imaging optical systems with different optical axes.

2. The image capturing apparatus of claim 1,
wherein based on the characteristic of the mounted lens unit, the control unit performs control such that, with respect to the same operation amount of the movement operation on the operation unit, the amount of movement of the position of the AF frame in a case where the mounted lens unit is the lens unit having the second characteristic is smaller than in a case where the mounted lens unit is the lens unit having the first characteristic.

3. The image capturing apparatus of claim 2,
wherein the control unit controls the movement of the position of the AF frame such that, with respect to the same operation amount of the movement operation on the operation unit, the amount of movement in the case where the mounted lens unit is the lens unit having the second characteristic is half the amount of movement in the case where the mounted lens unit is the lens unit having the first characteristic.

4. An image capturing apparatus on which a lens unit is mountable, comprising:
an acquisition unit configured to acquire a characteristic of a mounted lens unit;
an operation unit configured to receive a movement operation; and
a control unit configured to control, in accordance with the movement operation on the operation unit, a position of an AF frame indicating a region in which a defocus amount is to be detected for an image capture signal displayed on a display unit,
wherein, based on the characteristic of the mounted lens unit, the control unit performs control such that, with respect to the same operation amount of the movement operation on the operation unit, an amount of movement of the position of the AF frame is different depending on whether the mounted lens unit is a lens unit having a first characteristic in which a projection method of a lens is equidistant projection or the mounted lens unit is a lens unit having a second characteristic in which a projection method of a lens is central projection.

5. The image capturing apparatus of claim 4,
wherein the lens unit having the first characteristic and the lens unit having the second characteristic each have a plurality of imaging optical systems with different optical axes.

6. The image capturing apparatus of claim 4,
wherein the control unit controls the movement of the position of the AF frame such that, with respect to the same operation amount of the movement operation on the operation unit, the amount of movement in a case where a projection method of the mounted lens unit is equidistant projection is larger than the amount of movement in a case where the projection method of the mounted lens unit is central projection.

7. The image capturing apparatus of claim 4,
wherein the control unit controls the movement of the position of the AF frame such that in a case where the projection method of a lens of the mounted lens unit is equidistant projection, the amount of movement is increased according to an angle of view on the image capture signal displayed on the display unit, and in a case where the projection method of a lens of the mounted lens unit is central projection, the amount of movement is not changed according to the angle of view on the capture signal displayed on the display unit.

8. An image capturing apparatus on which a lens unit is mountable, comprising:
an acquisition unit configured to acquire a characteristic of a mounted lens unit;
an operation unit configured to receive a movement operation; and
a control unit configured to control, in accordance with the movement operation on the operation unit, a position of an AF frame indicating a region in which a defocus amount is to be detected for an image capture signal displayed on a display unit,
wherein, based on the characteristic of the mounted lens unit, the control unit performs control such that, with respect to the same operation amount of the movement operation on the operation unit, an amount of movement of the position of the AF frame is different depending on whether the mounted lens unit is a lens unit having a first characteristic in which a type of a lens is a fisheye lens or the mounted lens unit is a lens unit having a second characteristic in which a type of a lens is not a fisheye lens.

9. The image capturing apparatus of claim 8,
wherein the lens unit having the first characteristic and the lens unit having the second characteristic each have a plurality of imaging optical systems with different optical axes.

10. The image capturing apparatus of claim 8,
wherein the control unit controls the movement of the position of the AF frame such that, with respect to the same operation amount of the movement operation on the operation unit, the amount of movement in a case where a type of a lens of the mounted lens unit is a fisheye lens is larger than the amount of movement in a case where the type of the lens of the mounted lens unit is not a fisheye lens.

11. The image capturing apparatus of claim 8,
wherein the control unit controls the movement of the position of the AF frame such that in a case where a type of a lens of the mounted lens unit is a fisheye lens, the amount of movement is increased in accordance with an angle of view on the image capture signal displayed on the display unit, and in a case where the type of the lens of the mounted lens unit is not a fisheye lens, the amount of movement is not changed in accordance with the angle of view on the image capture signal displayed on the display unit.

12. The image capturing apparatus of claim 1,
wherein the operation unit receives the movement operation according to a movement of a touch operation.

13. The image capturing apparatus of claim 1,
wherein the operation unit receives the movement operation according to a press of a key.

14. The image capturing apparatus of claim 1, further comprising
a judgment unit configured to judge, based on information acquired through communication with the mounted lens unit, whether the mounted lens unit is the lens unit having the first characteristic or the lens unit having the second characteristic.

15. A control method for an image capturing apparatus on which a lens unit is mountable, the method comprising:
acquiring, by an acquisition unit, a characteristic of a mounted lens unit;
receiving, by an operation unit, a movement operation; and
controlling, in accordance with the movement operation on the operation unit, a position of an AF frame indicating a region in which a defocus amount is to be detected for an image capture signal displayed on a display unit,
wherein in the controlling, based on the characteristic of the mounted lens unit, control is performed such that, in accordance with the same operation amount of the movement operation on the operation unit, an amount of movement of the position of the AF frame is different depending on whether the mounted lens unit is a lens unit having a first characteristic of having an imaging optical system with one optical axis or a lens unit having a second characteristic of having a plurality of imaging optical systems with different optical axes.

16. A storage medium including a program for causing a computer to execute a control method for an image capturing apparatus on which a lens unit is mountable, the method comprising:
acquiring a characteristic of the mounted lens unit;
receiving a movement operation; and
controlling, in accordance with the movement operation on the operation unit, a position of an AF frame indicating a region in which a defocus amount is to be detected for an image capture signal displayed on a display unit,
wherein in the controlling, based on the characteristic of the mounted lens unit, control is performed such that, with respect to the same operation amount of the movement operation of the operation unit, an amount of movement of the position of the AF frame is different depending on whether the mounted lens unit is a lens unit having a first characteristic of having an imaging optical system with one optical axis or a lens unit having a second characteristic of having a plurality of imaging optical systems with different optical axes.
